(19) United States
(12) Patent Application Publication
(10) Pub. No.: US 2006/0036471 A1
(43) Pub. Date: Feb. 16, 2006

(54) Computerized automation of physician-patient interaction for streamlined physician workflow

(75) Inventors: Sethumadavan Sanjay-Gopal, Mayfield Village, OH (US); Daniel Karnadi, Stow, OH (US); Andrei Brateanu, Orange, OH (US)

Correspondence Address: TAROLLI, SUNDHEIM, COVELL & TUMMINO L.L.P., SUITE 1111, 526 SUPERIOR AVENUE, CLEVELAND, OH, 44114-1400, US

(73) Assignee: Penguin Medical Systems, Inc.

(21) Appl. No.: 11/112,886

(22) Filed: Apr. 22, 2005

Related U.S. Application Data
(60) Provisional application No. 60/564,346, filed on Apr. 22, 2004.

(51) Int. Cl. G06F 19/00

(52) U.S. Cl. 705/3; 705/2

(57) ABSTRACT

Systems and methods are provided for automating physician-patient encounters. A centralized database server stores information associated with a plurality of patents. A portable computing device includes a wireless component that is operative to retrieve information associated with a given patient from the centralized database server in response to input from a user. A display associated with the portable computing device displays the retrieved information to a user. At least one input device allows the user to input information about a specific encounter with the patient, the wireless component being operative to transmit the inputted information to the central database.

### FIELD OF THE INVENTION

The present invention relates generally to the recording and viewing of medical information of a patient on a display device coupled to a computer, and more specifically to the recording and viewing of a patient's health information on a handheld portable computer by a user in his or her office. The user is typically a physician, but could also be a nurse, physician assistant, or other staff in a physician office.

### BACKGROUND OF THE INVENTION

Due to rapid advances in computer technology people and organizations have increasingly adopted computers to help them examine and analyze real world data. One example is a physician's office that utilizes computers to store information such as name, addresses, etc. of its patients. Physician offices also utilize computers for storing financial information for services provided to their patients.

While physician offices have used computers for storing such basic information, physicians themselves have rarely used computers for storing and retrieving information about their patient's medical history that is recorded during the patient's visit to the doctor's office. The majority of physicians record patient information using sheets of paper and a pen or a pencil. These sheets of information are then stored as part of the patient's chart that is then stored in filing cabinets by office staff. While most often such charts are stored within the premises, in some cases these charts are stored in offsite locations.

On the day of the patient's visit to the physician's office, the office staff pulls the patient's chart from the filing cabinet to make it available for the physician to review prior to seeing their patient. While examining the patient, the physician records new information on a fresh sheet of paper that is then stored as part of the patient's chart. Any patient information, such as faxes of lab reports, that is received by the office is also manually stored by the office staff within the patient's chart.

The use of such paper-based patient charts has several drawbacks. Storing and retrieving of patient charts takes time and man-power, more so when the patient charts are stored in a site away from the physician's office. Manual processes are also error prone as papers could be misplaced or lost. If this happens the physicians could lose valuable information about their patients that could delay decision making. Important information could also be hidden within a thick file and could be overlooked by physicians during the course of their busy day.

Paper based systems also have several other inherent deficiencies. Healthcare today is very complicated wherein a patient could be ineligible for a particular type of medication based on the peculiarities of their insurance coverage. Also with the development of a multitude of medications it is impossible for a physician to know how each and every drug interacts with another. Paper based systems have no built-in mechanism for physicians to know either a patient's medication coverage, or the interactions of a patient's current medications with a new medication they would like to prescribe for the patient.

Such evolving complexity of healthcare makes it necessary for more accurate systems for storing and retrieving medical information about a patient. However, currently the systems for storing patient information about physician-patient encounters are predominantly paper-based process systems. While computer systems are used for storing some amount of patient information such as patient demographics, a limited number of systems allow for storing information about physician interaction. All of these systems can be confusing and intimidating to the users. Additionally, no system exists for automated generation of reimbursement codes as and when the physician is interacting with the patient. Such codes are needed for the physician to bill for service and be reimbursed for their service. All of the known prior art systems involve paper-based processes that are manual, time consuming, error prone, and subject to delays in reimbursement claim submittal. Physicians have to spend hours tracking what they did with the patient and looking up the Medicare code for the patient's condition. This process takes away valuable physician time, which is time that they otherwise could utilize either to enhance the care they provide their patients.

### SUMMARY OF THE INVENTION

The purpose of the present invention is to streamline the whole process of physician-patient encounter within a physician's office. It is intended to automate labor intensive manual processes by eliminating paper-based patient charts and processes. The invention utilizes advanced computer techniques for automating manual processes within a physician practice. One embodiment of the invention automatically routes incoming faxes and other information to the appropriate patient's electronic chart, filing it electronically with no manual intervention. The embodiment also automatically generates messages to the patient's physician when a new lab report becomes available, and automatically retrieves a patient's electronic chart at the time of the patient's visit to the physician office. Furthermore, the embodiment of the invention automatically generates email and other messages to the patient for purposes such as appointment reminders.

The invention also utilizes advanced computer techniques for automatically providing relevant and comprehensive information about a patient for the physician to review during the physician-patient encounter. An example of such information includes allergy alerts for a particular patient during the physician-patient encounter, and patient notes and reminders from a previous visit. Furthermore, the invention is targeted towards generation of diagnostic codes for physician reimbursement automatically, as and when the physician is entering information about his/her patient during the encounter. This happens during the patient's visit to the physician's practice facility. Such reimbursement codes are automatically generated based on detailed information stored during the physician patient encounter.

One embodiment of the invention comprises of six components—a retrieve schedule component, a retrieve patient information component, an encounter protocol selector component, an encounter recorder component, an encounter coder component, and an encounter billing component. All six components interact with a set of automation routines, although no embodiment of the invention is particularly limited to any given set of routines. The retrieve schedule component permits the physician to select a patient from their daily schedule. The retrieve patient information component loads all of the information about a patient that is selected by the user using the retrieve schedule component. The encounter protocol selector component selects a specific encounter protocol, based on the patient information that was loaded by the retrieve patient information component, and the specific physician user's preference.

The encounter protocol selector component automatically selects a protocol that displays the most relevant information based on the reason for the patient's visit, so that the physician can begin with a useful starting point during the patient encounter. Also the appropriate protocol could be a relevant starting point for nurses and other qualified individuals to record patient information for the physician to later review. The encounter recorder component permits the user to accurately record all information about the patient. The encounter recorder component allows for displaying information that is logical in light of the type and reason for the patient's visit with the physician. The user is guided through a systematic review of the patient during the patient encounter, so as to help the user perform a comprehensive review of the patient. One embodiment of the encounter recorder component permits the user to utilize a digital stylus to record encounters and handwrite patient notes. The encounter recorder component also permits the user to review scanned documents and mark them up using a stylus for further review at a later date or by some one else within the practice. The user is also able to dictate a detailed note using a microphone that is then automatically converted to text by the system. The encounter recorder component also is intelligent in providing warnings to the user at appropriate times based on standardized federal guidelines such as those recommended by the American Medical Association.

The encounter recorder component also provides all necessary information about the specific patient and diagnostic codes for the physician to use as part of their assessment of the patient. This information is then used by the Encounter Coder component to generate reimbursement codes for the patient. The Encounter Coder component utilizes automated techniques for automatically generating reimbursement codes that are based on the detailed information that is recorded by the user during the encounter and published federal reimbursement guidelines. The Encounter Billing component uses information about the patient's encounter as well as reimbursement codes to generate health claims that the physician can electronically transmit to insurance companies for billing and reimbursement.

In this manner, the invention provides a non-expert computer user with an environment to easily and accurately record and review medical information about a patient within a physician practice. The invention represents an integrated system starting from scheduling a patient through tracking the patient's lab and radiology results, coding of the physician's interaction with the patient, generating billing claims, and tracking the claims' process. In summary, the purpose of the invention is to help physicians in maintaining patient records in an electronic database to help streamline and automate physician workflow.

### BRIEF DESCRIPTION OF THE DRAWINGS

FIG. 1 is a schematic diagram of a computerized automation of patient encounters for streamlined workflow in accordance with the present invention;

FIG. 2 is a diagram of a computer hardware configuration in conjunction with which an embodiment of the present invention is implemented;

FIG. 3 is a diagram of a typical computer hardware configuration in conjunction with which an embodiment of the present invention is implemented;

FIG. 4 is a diagram of an alternative computer hardware configuration in conjunction with which an embodiment of the present invention is implemented;

FIG. 5 is a block diagram illustrating the general order of workflow in accordance with an embodiment of the present invention;

FIG. 6 is a screen shot from an embodiment of the present invention, showing the general workflow of FIG. 5 in accordance with an embodiment of the present invention;

FIG. 7 is a block diagram showing in more particular the Retrieve Physician Schedule component of FIG. 5;

FIG. 8 is a screen shot from an embodiment of the present invention, showing the retrieve physician schedule component of FIG. 5;

FIG. 9 is a block diagram showing in more particular the retrieve patient information component of FIG. 5;

FIG. 10 is a block diagram showing in more particular the encounter protocol selector component of FIG. 5;

FIG. 11 is a screen shot from an embodiment of the present invention, showing the encounter recorder component of FIG. 5;

FIG. 12 is a screen shot from an embodiment of the present invention, showing the encounter recorder component of FIG. 5 displaying user specified controls;

FIG. 13 is a screen shot from an embodiment of the present invention, showing controls that enable learning mechanism built into the encounter recorder component of FIG. 5;

FIG. 14 is a block diagram illustrating in more particular the workflow of generating referral letters in accordance with an embodiment of the present invention;

FIG. 15 is a block diagram showing in more particular the encounter billing component of FIG. 5; and

FIG. 16 is a block diagram showing in more particular a continuing education management component in accordance with an aspect of the present invention.

### DETAILED DESCRIPTION OF THE INVENTION

Invention Overview and Hardware Description

The Automated Clinical Encounter Manager (ACEM) is an advanced electronic health record workstation, comprised of software running on general-purpose hardware. The invention provides for an interactive environment in which to record and review disparate data organized into individual patient records by automated computer techniques. One particular embodiment of the invention provides a diagnostic environment for medical professionals such as physicians and nurses in a physician's office setting. The embodiment permits such professionals to view patient data that has been captured during previous patient visits to the physician's office, as well as other patient data that has been electronically captured. An embodiment of the invention permits such electronic data to have been captured digitally directly from the source of the data, for example laboratory computers that provide a patient's lab results. The embodiment also permits the electronic data to have been captured by converting paper based information using a scanner. The invention provides an interactive environment to allow the medical professionals to record and review all relevant patient information quickly and simply, and to create diagnostic reports for treating the patient.

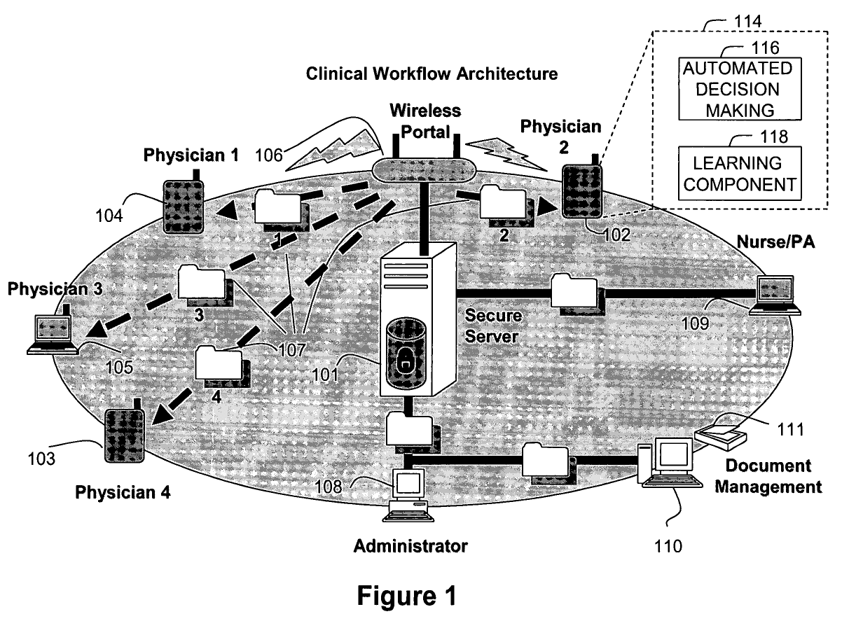

FIG. 1 shows the environmental context within which the invention is used. It is a schematic diagram of a computerized automation of physician-patient interaction for streamlined physician workflow in accordance with the present invention. As representative of the present invention, FIG. 1 illustrates that the invention includes a centralized database server 101 for storing electronic patient records and a handheld device, such as a Tablet PC 102 and 103 or a personal digital assistant 104 (PDA), or a laptop computer 105, through which the user reviews patient information and inputs information about the specific encounter with the patient. A wireless communication device 106 may be used for transmitting patient information 107 to a given handheld device (e.g., 102). The wireless communication device 106 utilizes published industry standards such as 802.11a, 802.11b, 802.11g, although no embodiment of the invention is so limited. This communication device 102 also communicates information about the patient back to the central database. Other computer systems may also be connected to the central database via local area network (LAN) cables that allows administrators 108, secretaries, and nurses 109 to input patient information. The system can also include an integrated device 110 to receive incoming patient information, such as faxes of lab reports and radiology reports and electronic lab results, and store the information in the appropriate patient's folder. The system can further include a scanning system 111 and software for converting paper documents to electronic form.

A given handheld device (e.g., 102) can include a user interface 114, implemented in software, that allows a user (e.g., a physician) to store and retrieve information on the device and on the centralized database server 101. The user interface 114 can adapt to different situations, providing different customizable sets of controls (e.g., buttons, tabs, or similar manipulatable objects provided on a display of the handheld device 102) to the user in response to characteristics of the user and patient condition. These characteristics can include, for example, the prior medical history of the patient, the identity of the physician, and the patient's reason for visiting the physician. To take a simple example, a patient might see the physician to determine if a cast can be removed from a broken leg. If reason for visiting is provided to the system, by an administrator 108 for example, the system can provide a default set of controls to the physician that includes a first control for calling up an x-ray report for the patient, a second control for generating a referral letter to a physical therapist, and a third control for notifying an administrator that it is necessary to set-up a follow up appointment. One skilled in the art will appreciated other situations in which a set of functions can be particularly useful for a given situation or physician. It will be appreciated that other controls can be made available beyond the provided set of default controls, within a menu structure, for example, but the default controls are provided directly into the physician's workspace for ease of access.

The user interface 114 can include an automated decision making component 116 that analyzes data, such as patient information, and makes decisions based on the analysis. This allows a number of tasks associated with medical practice to be automated. For example, the user interface 114 can retrieve information from a database associated with the centralized database server 101 or one or more external sources (e.g., Internet databases) in response to information provided by the user, such as the patient's name, and stated reason for visiting the physician. It will be appreciated that the automated decision making component can select appropriate information for the user based on the provided patient information without further input from the user. Other functions of the user interface can include automated retrieval of patient information, such as lab results and information from prior visits, the generation of referral letters and prescriptions, insurance and Medicare billing, management of continuing education requirements for the physician, and schedule management. These automated functions allow the user to perform previously time consuming tasks literally with the push of a key or the touch of a stylus.

In accordance with an aspect of the present invention, the user interface 114 is configurable to adapt to the needs of a given physician-patient encounter. For example, the user interface 114 can be configurable by a physician to customize the controls provided to the physician, such that controls favored by the physician are more likely to be selected in a given situation. In addition, the user interface can include a learning component 118 for optimizing the behavior of the user interface 114. Accordingly, the user interface 114 can adapt the default set of controls and the default set of available data choices provided in a given situation according to the controls and data choices selected in previous, similar situations. The automated functions within the system can also be made adaptable. For example, a Medicare billing component of the user interface 114 can learn from rejected claims to more appropriately code and format the generated claims at future time instances. This allows the system to continuously adapt to the user's needs as well as the needs of the physician practice.

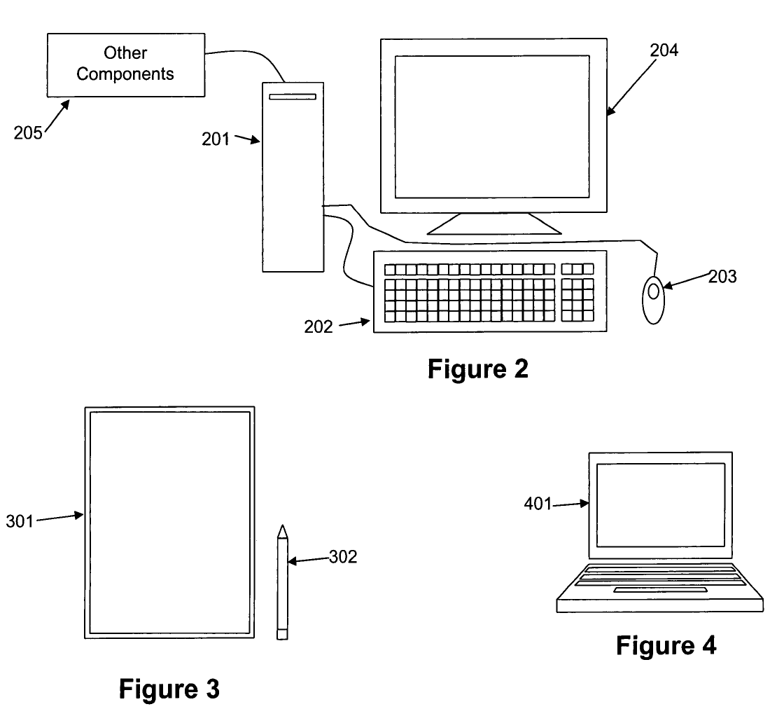

The invention is not limited to any particular type of general-purpose hardware. Examples of such hardware, however, are shown in FIGS. 2-4. The hardware shown in FIG. 2 includes a computer 201, keyboard 202, pointing device 203, display device 204, and other components 205 (represented by a block diagram). FIG. 3 shows a typical hardware, that includes a portable computer 301, and a digital pen 302. FIG. 4 shows a laptop computer 401 with a keyboard and pointing device integrated into the computer. Portable computer 301 is in one embodiment Microsoft Windows compatible. More particularly portable computer 301 is a Microsoft Windows Tablet PC, running Microsoft Windows XP Tablet PC Edition, with a graphical interface. The invention is not limited, however, to any particular computer 201, portable computer 301, or laptop 401.

The database server 101 of FIG. 1 is also not limited to any particular type of general purpose hardware. Typically it is a computer running Windows operating system, although no embodiment of the invention is so particularly limited.

As shown in FIG. 3, pointing device 203 is a mouse, although the invention is not limited to any particular pointing device. For example pointing device 302 may also be a point stick, trackball, or a touchpad. The pointing device has three buttons, although no embodiment of the invention is so particularly limited. As shown in FIG. 4, the digital pen 302 is a stylus, although the invention is not limited to any particular digital pen. For example the digital pen 302 may also be a resistive stylus as for a PDA or a capacitive stylus for a Tablet PC. In addition to the pointed end, the digital pen also has two buttons, although no embodiment of the invention is so particularly limited. As described herein erasing using the digital pen refers to the removal of markings (text, lines, pictures, etc.) using one of the buttons at the opposite end of the pointed end (similar to a pencil).

Database server 101, Computer 201, portable computer 301, or laptop computer 401 may also have the capability of hooking up to a network (such as a LAN, or a HL7 network), may have Internet or Intranet capability, or have access to a HL7 server. Each of these is well known to those skilled in the art. Not shown in FIG. 1, is that database server 101 typically includes a central-processing unit (CPU), a random access memory (RAM), and a read-only memory (ROM). The CPU, RAM, and ROM may be of any type. Also not shown in FIG. 1 is that database server 101 usually comprises of a fixed storage devices such a RAID hard disks, archival devices such as a DVD writer or a tape writer. Conversely, such components may be external to computer 201 in which case they are part of other components 205. Also not shown in FIGS. 1-4 is that portable computers such as Tablet PC 102, PDA 103 or laptop computer 104 may also have devices integrated into them for wireless access to the intranet or internet. Conversely, such devices would be detachable and re-attachable, such as for instance a wireless card. No embodiment of the invention is also limited as to the programming language by which the software is implemented. However, in one embodiment, the language is the object-oriented programming language C#.

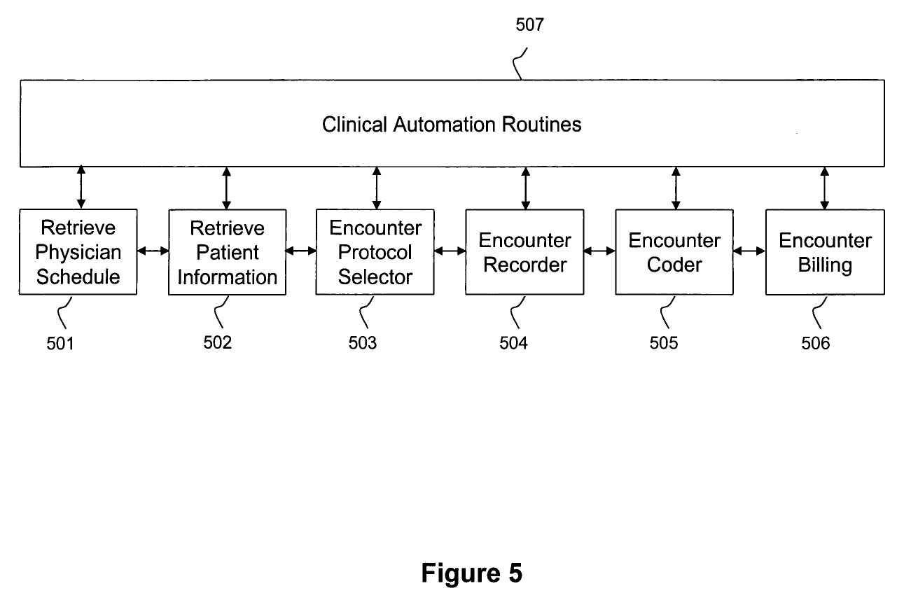

Referring now to FIG. 5, the general workflow of the user interface is shown as a block diagram. The ordering of the workflow permits a user to quickly retrieve the user's schedule and patient information over a network, such as that of a physician office; rapidly review the relevant patient information that was entered during prior patient visits, or at an earlier time in the day during the same visit, either by user himself or by some other qualified individual within the physician office; record in detail all relevant new information during the current visit based on an automatically selected encounter protocol; automatically code the encounter to generate reimbursement codes for claims; generate a bill for the encounter that can be electronically transmitted to the patient's insurance company for reimbursing the physician's office for the rendered service. The workflow is organized in such a manner that while recording all details of the encounter the user can make and record a diagnosis; generate orders such as lab orders; prescribe medications and either print them or electronically transmit the prescriptions to pharmacies via a phone line or via the internet; generate referral letters and print reports; and update patient information to provide instant access for other individuals who need access to the patient information either within the physician's office or elsewhere via the internet.

Also shown in FIG. 5 is Clinical Automation Routines 507 which is accessed by and provides data to each of the components 501, 502, 503, 504, 505, and 506. This Automation Routines 507 contains computer algorithms by which data and patient information is selected and presented to the user along with other information such as possible diagnosis codes, codes for ordering lab and radiology procedures, and available medications and their interactions. No embodiment of the invention is limited to any particular set of Automation Routines 507.

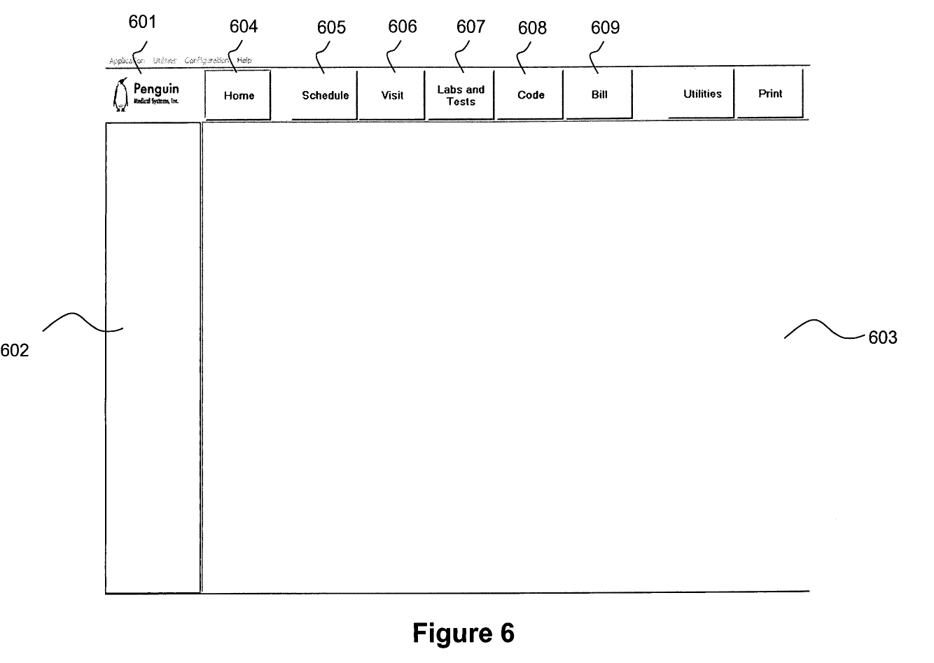

FIG. 6 shows a representation of the screen of one embodiment of the present invention. The screen shot includes a workflow area 601, a control area 602, and an information area 603. The workflow area 601 contains home button 604, schedule button 605, visit button 606, labs button 607, code button 608, and bill button 609.

Retrieve Physician Schedule Component

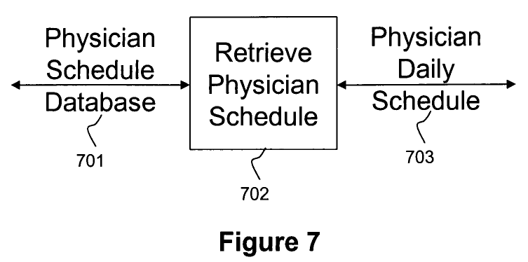

Referring to FIG. 7, retrieve physician schedule component 501 is now shown in further detail. Input 701 to retrieve physician schedule component includes data retrieved from a scheduling database from the database server 101 according to the user's choice of a particular day. Output 703 includes the list of patients scheduled for the day, detailed information about patients, along with other information such as the reasons for the patient encounter. The list of patients and other information is retrieved over a network, connected either by wires or wirelessly, or from a file system. Each of these data sources is well known those of ordinary skill within the art.

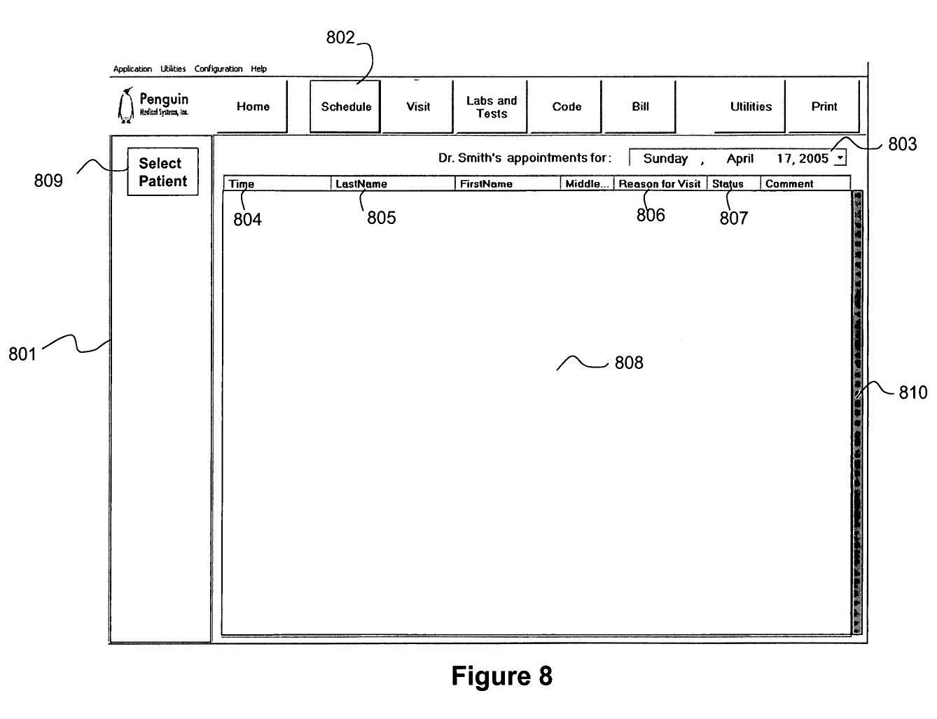

The retrieve physician schedule component in one embodiment of the invention corresponds to detailed information about all of the patients scheduled for the selected day. This information is displayed in a window having selectable fields. The user is permitted to select, search, sort the list by patient name, time of day, patient status (arrived at physician's office, room where patient is located), and reason for wanting to meet with physician. This is shown in FIG. 8, which is a screen shot from an embodiment of the present invention. Screen shot 801 includes the schedule button 802, a user selectable date 803, time of day 804, the patient name 805, a reason for the patient's visit 806, the patient's status 807, a patient list and info area 808, and a patient selection button 809. When user clicks on the schedule button 802 in one embodiment of the invention, the schedule of patients for the current day is shown in the patient list 808. By selecting a different day using the user selectable date 803, the user can display the schedule for any day in any year. If any one of the buttons 804, 805, 806, 807 is selected the user is presented with a reordered list of patients based on the specific button selected. If there are a large number of patients scheduled for the day and not all of them can be shown on the screen at the same time, then scroll bar 810 permits a user to scroll up or down to view the information desired. When the patient arrives on the day of the appointment, the admitting nurse or receptionist marks the patient as having arrived. If the patient is located in a particular room of the practice facility, this information is also entered into the main database server 101. During the day, the user can access the entire schedule on a portable device 301, including the status of the patient, whether they have checked in, which room they are in, etc.

Retrieve Patient Information Component

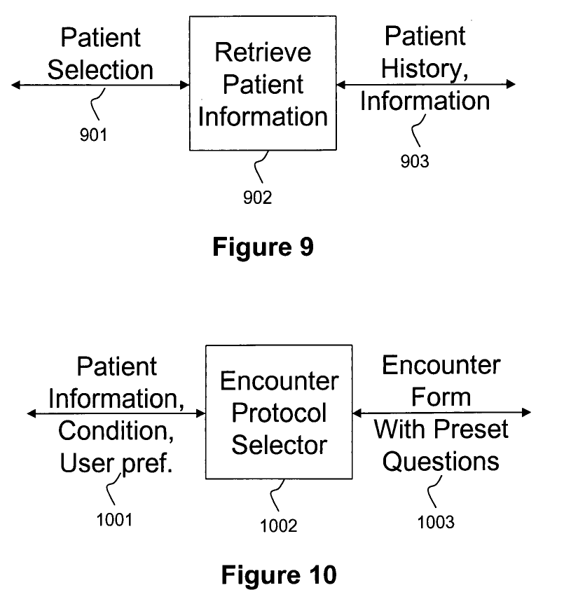

When the user selects any patient within the patient list 808, the retrieve patient information component 502 is activated. The retrieve patient information component 502 is illustrated in more detail in FIG. 9, as compared to its presentation in FIG. 5. Input 901 to retrieve patient information component includes patient selection by user. Output 903 of retrieve patient information component is all of the relevant patient information such as, but not limited to, a list of all previous physician-patient encounters, all of the patients diagnosis, and a list of the current medications for the patient. Upon activation the retrieve patient information component obtains all of the patient information and displays them on the screen for the user. The retrieve patient information component 502 automatically retrieves the patient's complete electronic chart and, using Automation Routines 507 compares it to the reasons for previous visits as well as the prior medical conditions of the patient. The retrieve patient information component 502 also runs the patient's information against a screening check to flag the patient's chart using the Automation Routines 507. The screening checks are completely customizable by the practice facility. An example of such a screening check is to see if the patient is female, over 40, and whether or not she has had a mammogram within the past 2 years. The retrieve patient information component 502 will inform the user who is scheduling the patient if the patient does not pass such a screening check, and will also, using Automation Routines 507, electronically transmit a message to help the scheduling person schedule the mammogram and any other tests that need to be done for the patient. Thus the retrieve patient information component 502 searches an available database using the patient's reason for the visit to extract information that will be useful to the physician. The user can use this information to better prepare for the patient. The retrieve patient information component 502 can automatically generate warnings and alerts to the user whenever any new information (e.g., new lab reports, etc) becomes available.

In addition, in one embodiment of the present invention, the retrieve patient information component 502 works in concert with the Automation Routines 507 to perform a detailed trend analysis of the patient information. The retrieve patient information component 502 then compares the results of the detailed trend analysis to a plurality of databases in the internet to provide automated profiles of the specific patient in comparison to those of various patient populations. This comprehensive analysis is then made available to the user to use during the encounter with the patient.

Encounter Protocol Selector Component

Referring to FIG. 10, the encounter protocol selector component 503 is shown in more detail, as compared to as it is shown in FIG. 5. Input 1001 to the encounter protocol selector component include, but is not limited to, the patient's condition, reason for the patient's visit, and the specific physician reviewing the patient. Output 1003 of the encounter protocol selector includes a specific encounter protocol that governs the ordered manner in which the user reviews the patient's current condition.

The encounter protocol includes presets that determine which controls (buttons, checkboxes, text areas, etc.) are actually displayed to the user while reviewing the patient using the encounter recorder component 504. With respect to the presets, the encounter protocol governs the behavior of the user as the user steps through the workflow. This is, the encounter protocol selector component 503, will only select a protocol that contains a set of controls that are most useful to user based on the specific user's preferences. For instance for a particular patient's condition, one user might prefer to use just a checkmark to record an item within the encounter recorder 504. Another user might prefer to handwrite detailed notes to record the same item within the encounter recorder 504. A third and different user might record detailed notes about the same item by voice dictation using a microphone. The encounter protocol selector 503 uses its input 1001, and the Automation Routines 507, to select only the most appropriate protocol to be used within the encounter recorder component 504.

Encounter Recorder Component

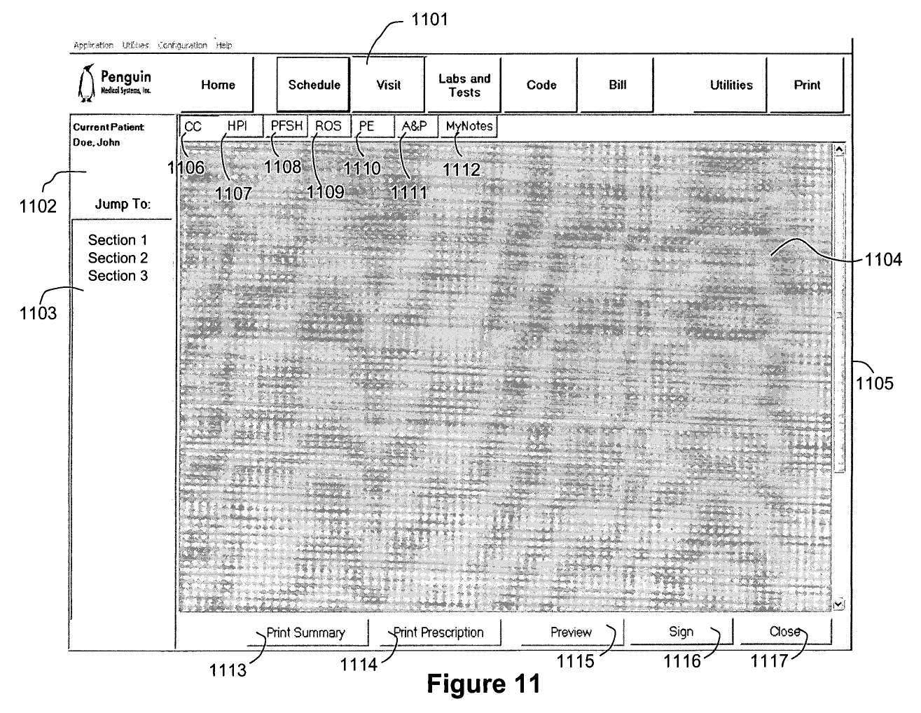

When the user selects the Create Encounter button 809, the protocol selected by the encounter protocol selector triggers the encounter recorder component 504. The encounter recorder component 504 provides a control interface for the user according to the selected encounter protocol, such that the preset controls associated with the selected encounter protocol are provided as part of the control interface. A screen shot of one embodiment of the encounter recorder component 504 is shown in FIG. 11. Referring to FIG. 11, the encounter recorder component 504 is displayed on the screen when the user selects the Visit button 1101. The encounter protocol component displays the active patient name 1102, various sections 1103 within the protocol selected by the encounter protocol selector component 503, and various protocol parts buttons 1106, 1107, 1108, 1109, 1110, 1111, and 1112. Also, as shown in FIG. 11, the encounter protocol recorder component 504 displays a set of action buttons—summary button 1113, prescription button 1114, preview button 1115, signature button 1116, and a close button 1117.

Any encounter protocol selected by the encounter protocol selector component 503 can be divided into different parts each of which has a unique name. Each of these parts is associated with a protocol part button and these buttons are displayed to the user by the encounter protocol recorder component 504. FIG. 11 shows one embodiment of the invention wherein the selected protocol has a chief complaint part button 1106 (CC), a history of present illness part button 1107 (HPI), a patient history part button 1108 (PFSH), a review of systems part button 1109 (ROS), a physical exam part button 1110 (PE), a assessment and plan button 1111 (A&P), and a my handwritten notes part button 1112 (MyNotes). No embodiment of the invention is limited to any particular set of protocol part buttons.

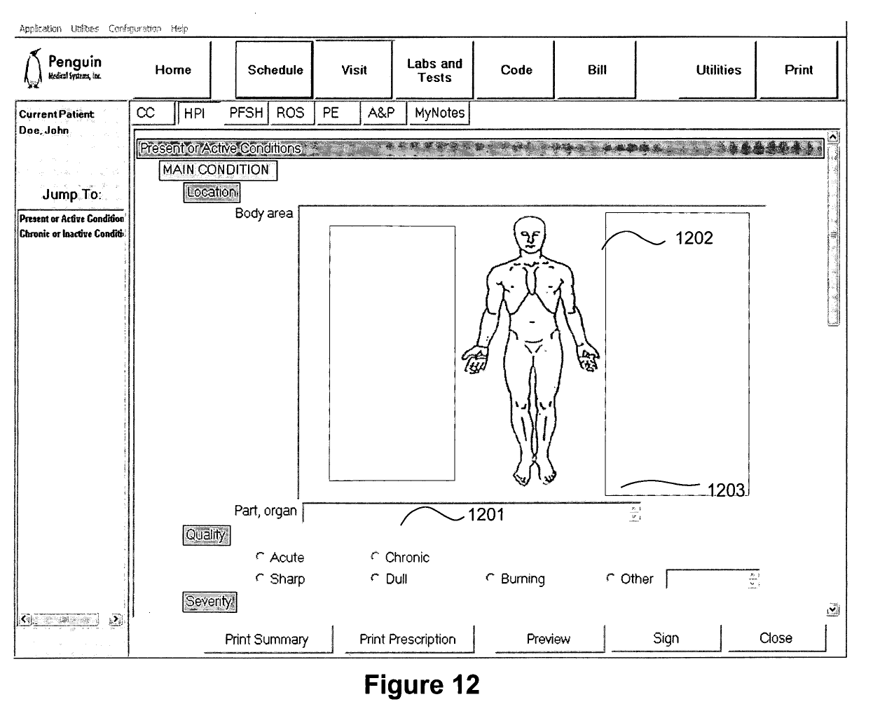

Each part of an encounter protocol can be divided in to various sections that are displayed to the user by the encounter protocol recorder component 504. Referring to FIG. 11, one embodiment of the encounter protocol recorder 504 shows the sections 1103 for the user selected protocol part button. When the user selects a particular part protocol button, the various sections within the selected part of the protocol are displayed in the section display area 1103. In addition, the encounter protocol recorder component 504, displays in the protocol controls area 1104 all user specific controls that pertain to that specific part of the protocol. Referring to FIG. 12, shown is a screen shot from one embodiment of the invention, wherein the encounter recorder component 504 displays a circular button 1201, a diagram 1202 on which the user can draw illustrations or handwrite notes, and a text area 1203 in which the user can handwrite notes.

When the user selects the create encounter button 809, the encounter protocol recorder component 504 creates an electronic visit for the patient. Along with the visit, the encounter recorder component 504 automatically retrieves the patient's complete electronic chart and, using automation routines 507, and compares it to the reasons for previous visits as well as the prior medical conditions of the patient. Using automation routines 507, the encounter recorder component 504 also runs the patient's information against a screening check to flag the patient's chart. Such flags are displayed to the user using highlights in the protocol controls area 1104.

During the physician's interaction with the patient, the physician interacts with the protocol parts button to selectively display user chosen parts of the protocol. In addition the user can quickly navigate to a specific section within a protocol part by selecting a specific section within the section display area 1103. For the current encounter, the user can quickly enter the relevant information using the user specific controls located within the protocols controls area 1104. The entry of this information is streamlined to enable the user to cover all necessary information according to published Medicare standards and guidelines. The user updates the patient information electronically. Using the automation routines, the encounter recorder component 504, generates messages that can then be received by other users within the network. In one embodiment of the invention, the scheduling secretary is automatically informed if the user orders any additional visits or wants the patient to schedule a follow-up visit.

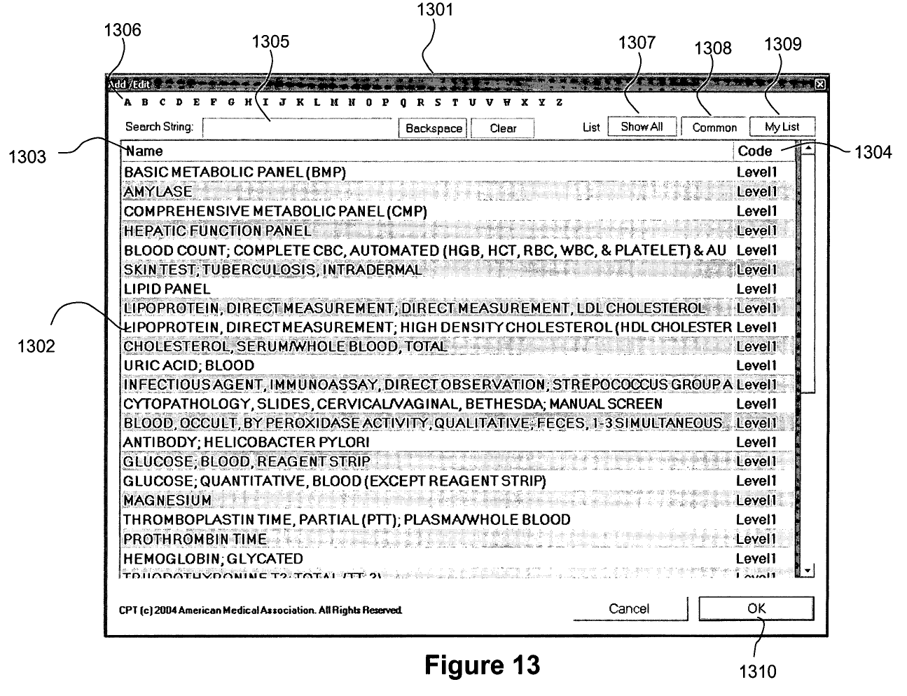

The encounter recorder component 504 also uses the automation routines 507 as a learning mechanism that can then be applied to optimize the encounter recorder component 504 on subsequent uses. This is shown in FIG. 13, which is a screen shot from one embodiment of the present invention. Screen shot 1301 includes data list 1302 sorted by name 1303 or code 1304. Screen shot 1301 also shows show all button 1307, common button 1308, and my list button 1309. Based on various factors, including but not limited to, user habits, user preferences, clinical trends, diseases frequencies, disease seasonality's (such as flu seasons), the encounter recorder component 504 displays the most relevant information for the user to select quickly during the patient encounter. Also, the encounter recorder component 504 allows the user to quickly locate specific information using filters that the user can create using a text box 1305 and letters 1306.

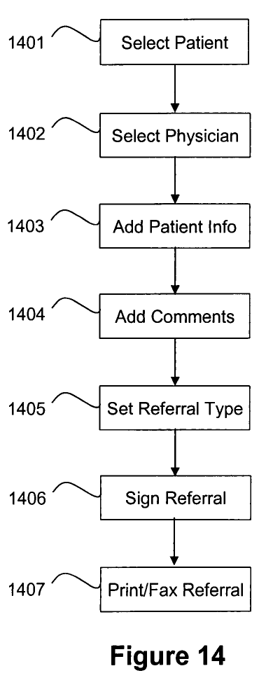

The encounter recorder component 504 allows the user to quickly perform other patient specific actions. Referring to FIG. 14, shown is a block diagram of the workflow in generating a referral letter for a patient. The ordering of the workflow permits the user to select a patient 1401 for whom the referral letter is needed; select a physician 1402 to whom the patient is being referred to; add relevant patient info 1403, including, but not limited to patient's condition, past medical history, current medications, etc.; add additional comments 1404; provide specific requests by choosing a referral type 1405; sign the referral 1406, either electronically or by using a digital pen 302; print, fax, email or otherwise electronically transmit the referral 1407.

The encounter recorder component 504 permits the user to quickly perform other specific actions during the patient encounter. Referring to FIG. 11, in one embodiment of the present invention, the user can quickly view a one-page summary of the encounter by selecting the print summary button 1113, quickly electronically transmit or fax the prescription to the pharmacy by selecting the print prescription button 1114, view the entire encounter by selecting the preview button 1115, sign the encounter using the sign button 1116, and close the encounter using the close button 1117.

Encounter Coder Component

At the completion of the patient's visit, the user clicks on the sign button 1116. This user action triggers the encounter coder component 505 to use the automation routines 507 and generate the Medicare reimbursement code for the specific encounter. Within a few seconds, the complete code is generated for the physician to review using the code button 808. Once the physician reviews this, he/she can trigger the billing for the specific visit. In one embodiment of the present invention, the encounter coder component continuously and incrementally generates the reimbursement codes, as the user records the details of the patient encounter using the encounter recorder component 504. The reimbursement code for the entire visit is instantaneously available at the completion of the encounter, and during the course of a normal workday of 40 patients, this can provide a significant time savings to a busy user.

Encounter Billing Component

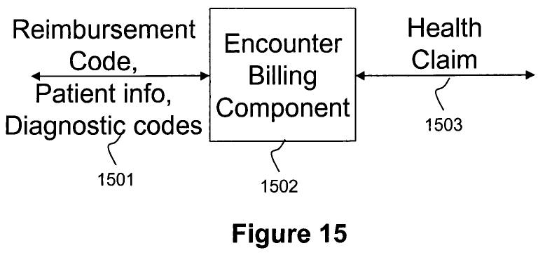

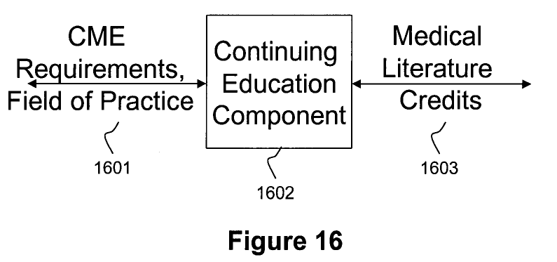

Referring to FIG. 15, the encounter billing component 506 is shown in greater detail. Input 1501 to the encounter billing component is the reimbursement code generated by the encounter coder component 505, and patient information, including, but not limited to eligibility and insurance carrier information. Output 1503 of the encounter billing component is a health claims file that can be electronically transmitted to the appropriate insurance company or governmental agency using the Automation Routines 507. The encounter billing component 506 can be made adaptable such that it learns from rejected claims. For example, when a claim is rejected, the encounter billing component 506 can analyze the rejected claim to determine any errors leading to the rejection. The encounter billing component 506 can then correct for the determined error to avoid difficulties with future billings and greatly reducing, perhaps even eliminating, claims rejections.

Continuing Education Management Component

A continuing education management component 1602 can be provided to continuously educate the user by extracting educational material 1603, such as medical journal articles, from a plurality of scientific databases. For example, physicians are generally required to accumulate, on an annual basis, a minimum number of continuing medical education (CME) credits to retain their certification. Input 1601 to the continuing education management component 1602 can be the physician's CME requirements and fields of practice. The continuing education component makes use of the Automation Routines 507 to retrieve various scientific and educational information from a plurality of databases on the internet. Output 1603 of the continuing education management component 1602 is continuously retrieved articles of interest from these various accredited sources. This allows the busy physician to review the retrieved educational materials at their convenience and acquire CME credits as they see patients during their normal daily workflow. The continuing education management component 1601 thereby provides a more flexible and convenient alternative to attending conferences and taking other special measures outside of the daily workflow to acquire CME credits.

Advantages of the Present Invention

As has been described and in combination with the drawings, one embodiment of the invention permits a user to interact with, review, and record, important patient healthcare information. It provides a collaborative environment that is simple to use, and enables a non-expert computer user to quickly and accurately access and update important patient information. The general workflow framework described hereto provides simple ways for recording patient information that is easy to learn by various individuals within a practice. The embodiment of the invention helps to streamline the workflow associated with a patient-physician encounter. Multiple individuals in the chain can all access the patient's record at the appropriate times. Data is continuously updated to help all individuals complete their responsibilities in a short time. The invention has several unique advantages that help a practice efficiently organize its work to achieve improved accuracy, performance, and operational efficiencies.

First and foremost, the invention provides increased flexibility to various users within a practice to customize and organize their encounter recorder interface. Customized protocols allow users to input the most relevant info as they see it. A unique and significant advantage of the present invention is that users can now customize the user interface as per their convenience, and more importantly, according to their computer proficiencies. By provided simple and easily understandable workflow and associated controls, the various components hereto described provide a non-overwhelming user interface. The invention allows users to not only customize the information that they can record and review for each patient encounter, but also how this information can be recorded. The invention permits novice computer users to use simple tools, similar in form to a pen and paper. At the same time the invention allows more advanced users, within the same physician practice, who are comfortable with computers to customize their displays using more conventional computer specific tools such as buttons and check boxes. The uniqueness of the invention is in its adaptation to the skill levels of its users and represents a significant advantage to a busy physician practice.

Secondly, as described hereto, the invention provides a high degree of automation for physician practices. By utilizing advanced automation algorithms the invention saves time, decreases errors, and improves accuracy. The present invention is advantageous over prior art because the manually intensive paper-based process is eliminated. Time lost in manually receiving paper faxes and filing them as part of the patient's chart can now be reclaimed using document management algorithms within the invention. The document management algorithms route incoming electronic information, such as faxes of lab reports, to the targeted recipient. Accordingly, a received document can be automatically assigned to an associated patient, physician, and administrator and stored in an appropriate location within the database. By automatically generating messages from these incoming patient information, the invention results ensures that appropriate healthcare providers are informed of all relevant information about a patient. In addition, users of the system can be notified of actions taken by the automated decision making component of the system. In automatically notifying its users, the system automatically generates individual “to do” lists, that users can continuously monitor to help improve the practice's operational efficiency. Automated computer filing of patient information eliminates errors associated with manual misfiling of patient information. The invention allows for the electronic transmittal of prescriptions to pharmacies and decreases chances of medication errors. The present invention automatically searches an available database using the patient's reason for the visit to extract information that will be useful to the physician. The physician can use this information to better prepare for the patient. Automated routines provided by an embodiment of the invention provide specific warnings and other alerts based on automated retrieval of information. This ensures that the users are reminded and informed about important patient information, so as to enable them to provide better patient care.

Advanced learning techniques built into the automation routines allow an embodiment of the invention to present relevant information without overwhelming the user with a lot of unnecessary data. The uniqueness of the invention is in its ability to learn and adapt to various individuals within the same practice. By using this learning to intelligently present only relevant information the invention saves valuable time for users, time that can be spend in improving the physician-patient interaction process. Automated protocol selection saves time and effort, and ensures that all relevant patient information is captured to maximize patient care.

The present invention eliminates the labor-intensive Medicare reimbursement coding process by automatically generating reimbursement codes. This frees up valuable physician time to help provide better patient care because physicians do not have to be aware of the latest Medicare policies for coding purposes. A unique feature of the present invention is in the seamless manner in which it weaves the coding process into the physician-patient encounter. Also, automated computer based coding facilitated by the automation algorithms within the invention prevents coding errors and can result in a highly consistent coding by various users within the practice. By automatically generating health claims the invention saves a practice valuable time that can otherwise be used to improve patient care.

The present invention allows for interactive manipulation of patient charts by multiple individuals within a practice (e.g., scheduling service). Additionally, the present invention allows patients to enter their profiles and data at the time of signing on to a physician as a primary care physician. Further, a patient can schedule his/her visit to the physician and provide relevant information about the reason for the visit so as help physicians prepare for their patient. Finally, the invention can include a verification component that allows for electronic verification of patient's insurance information via a “handshake” between the system deployed in the physician's office and the database server of the insurance company. Based on the information received, and using the automation routines, the invention allows for automated notification of office staff to reconcile any insurance eligibility discrepancies.

From the above description of the invention, those skilled in the art will perceive improvements, changes, and modifications. Such improvements, changes, and modifications within the skill of the art are intended to be covered by the appended claims.

Having described the invention, the following is claimed:

1. A system for automating physician-patient encounters comprising:
a centralized database server that stores information associated with a plurality of patients; and
a portable computing device, comprising:
a user interface that provides a default set of controls to a user on an associated display based on at least one characteristic of the user and a given patient; and
at least one input device that allows the user to input information about a specific encounter with the patient, the user interface retrieving information associated with the given patient from the centralized database server in response to input from a user.

2. The system of claim 1, the user interface further comprising:
an encounter protocol component for storing and retrieving a plurality of encounter protocols for patient encounters, a given protocol representing an associated set of default controls provided to the user;
a patient information component for storing and retrieving patient information; and
an encounter protocol selector component that selects a encounter protocol according to at least one selection criteria.

3. The system of claim 1, the user interface further comprising:
an encounter recorder component that retrieves desired patient information from the central server and record information obtained during an encounter with a patient; and
an automated learning mechanism that learns the preferences of the user as to optimize the performance of the encounter recorder component.

4. The system of claim 1, the at least characteristic comprising at least one of a medical condition of the patient, a reason for a patient's visit, and the identity of the user.

5. The system of claim 1, wherein the user interface is configurable by the user to customize the control interface.

6. The system of claim 1 the user interface further comprising a document management algorithm that automatically analyzes documents, routes the documents to an associated physician, and automatically stores routed documents associated with a given patent in an appropriate patient folder on the centralized database, the routed documents including at least one of lab reports, diagnostic images, and scanned electronic documents.

7. The system of claim 6, the document management component being operative to electronically receive patient lab reports and diagnostic images of the patient and store them in at the central database server.

8. The system of claim 1, the user interface further comprising:
a retrieve physician schedule component for storing and retrieving a schedule for the user;
a verification component for verification of the eligibility of the patient for procedures and medications;
an encounter coder component to provide accurate billing codes for a user based on detailed encounter information for billing and reimbursement; and
an encounter billing component for generating a health claim for an encounter.

9. The system of claim 1, wherein the user interface further provides for the user to create lists of common diseases, lab procedures, radiology procedures and medications for quick lookup and retrieval.

10. The system of claim 1, the user interface being operative to electronically transmit a prescription for the patient to a pharmacy.

11. The system of claim 1, the user interface comprising a mechanism for the automated generation of messages to the patient.

12. The system of claim 1, wherein the user interface comprises specific user interaction items that enable the automated calculation of insurance reimbursement codes.

13. The system of claim 12, wherein the user interface provides continuous information to the user about the reimbursement code for the encounter.

14. The system of claim 1, wherein the portable computing device is operative to communicate wirelessly with the centralized database server, the system further comprising at least one computing device connected to the centralized database server via a wired connection.

15. A method for the automatic acquisition and display of information to a user comprising the steps of:
retrieving a complete electronic chart of a patient from a central server in advance of a visit with the patient;
searching at least one available database based on information associated with the patient to extract information that will be useful to the user;
comparing the electronic chart to information associated with at least one previous visit and prior medical conditions of the patient;
evaluating the electronic chart according a plurality of screening criteria; and
flagging the electronic chart according to the evaluation of the electronic chart.

16. The method of claim 15 further comprising the step of the user accessing an entire schedule for the user on a handheld device, including the status of each of a plurality of patients, whether a given patient has checked in, and in which room each patient is located.

17. The method of claim 15 further comprising the step of automatically generating warnings and alerts to the user whenever any new information becomes available, the new information comprising at least one of a new lab report, a referral letter, and a reminder from a previous visit.

18. The method of claim 15 above further comprising the step of the user adding information about a given patient visit, the adding of the patient information including at least one of dictating relevant information using a microphone for storing as part of the patient's record and writing information onto a portable computing device via an associated stylus.

19. The method of claim 18 further comprising the step of generating a Medicare code and billing for the visit.

20. The method of claim 18 further comprising the step of automatically informing a secretary if the user orders any additional visits for the patient.

21. The method of claim 15 further comprising receiving at least one of a desired appointment time for the patient, demographic information associated with the patient, and past medical history of the patient at the central server from a remote location, such that the patient provides information to the central server prior to visiting an office associated with the user.

22. The method of claim 15, further comprising verifying the eligibility of the patient for insurance coverage for specific procedures and medications.

23. The method of claim 15, wherein searching at least one available database includes searching at least one medical database via the Internet.

24. The method of claim 15, further comprising:
receiving a rejected insurance claim;
analyzing the rejected claim to determine an error responsible for the rejection; and
adjusting the preparation of future insurance claims as to correct the determined error.

25. A computer program product, fixed in a tangible medium and executable in at least one processing component of a distributed computing system comprising:
a database that stores information associated with a plurality of patients;
a retrieve patient information component that retrieves information associated with a selected patient from the database;
an encounter protocol component for storing and retrieving a plurality of encounter protocols, a given protocol having an associated set of default controls provided to a user;
an encounter protocol selector component that selects a encounter protocol according to at least one selection criteria; and
an encounter recorder component that provides a control interface for the user according to the selected encounter protocol, such that the user can retrieve desired patient information from the database and record information obtained during an encounter with a patient.

26. The computer program product of claim 25, further comprising an automated learning mechanism that learns the preferences of the user as to optimize the performance of the encounter recorder component.

27. The computer program product of claim 25, further comprising:
a scheduling component for storing and retrieving a schedule for the user;
a patient verification component for verification of the eligibility of the patient for procedures and medications;
an encounter coder component to provide accurate billing codes for the user based on recorded information from the encounter with the patient for billing and reimbursement; and
an encounter billing component for generating a health claim for the encounter.

28. The computer program product of claim 25, further comprising:
at least one automation routine that allows for automated communication between physicians, nurses, office staff, billing staff, and patients; and
an automated decision making component for analyzing data and taking automated decisions based on the analysis.

29. The computer program product of claim 25, further comprising at least one automated document management algorithm for automatically analyzing documents and making decisions based on the contents of these documents.

30. The computer program product of claim 25, further comprising a continuing education management component for continuously educating the user by extracting educational material from a plurality of scientific databases.
